(19) United States
(12) Patent Application Publication
(10) Pub. No.: US 2002/0122756 A1
(43) Pub. Date: Sep. 5, 2002

(54) Active coating compositions for steam crackers

(76) Inventors: Thomas E. Paulson, Corning, NY (US); Tinghong Tao, Big Flats, NY (US); Jennifer M. Torns, Painted Post, NY (US); Donald M. Trotter JR., Newfield, NY (US)

Correspondence Address: CORNING INCORPORATED, SP-TI-3-1, CORNING, NY, 14831

(21) Appl. No.: 09/748,034

(22) Filed: Dec. 22, 2000

(51) Int. Cl. B01J 8/02; B01J 35/02

(52) U.S. Cl. 422/198; 422/211

(57) ABSTRACT

One aspect of the present invention is a furnace component comprising an inorganic material that is exposed to a gas stream comprising hydrocarbon compounds, wherein at least a portion of the exposed inorganic material comprises a catalyst that promotes a hydrocarbon reaction to produce an olefin. The inorganic material may be a glass, a glass-ceramic, or a ceramic and may be coated onto the inside wall of a hydrocarbon cracking reactor or may be used as particles, powder, beads, monoliths, or other structured forms. The glass-ceramic material may further comprise a catalyst that facilitates carbon gasification.

Another aspect of the present invention provides a method of making a furnace component, the method comprising the steps of a) melting together the components of a base inorganic material and a catalyst that promotes a carbon reaction to produce an olefin and, b) cooling the melt to provide a solid composition.

### BACKGROUND OF THE INVENTION

The present invention is concerned with improvements in the thermal cracking of hydrocarbons, such as ethane, propane, butane, naphtha, or gas oil to form olefins, such as ethylene, propylene, or butenes.

In the polymer industry, the productivity or yield of olefins as monomers is one of the most important factors determining the process and economic efficiency. Attempts to improve olefin yield in steam cracking have included the optimization of the thermal cracking process by using steam for dilution and heat input as well as the implementation of catalytic cracking and catalytic dehydrogenation schemes.

Any candidate method for improving the yield of olefins in a thermal cracking process must be suited to the operating constraints imposed by the process. At the heart of a thermal cracking reactor is a pyrolysis furnace comprising a firebox through which runs an array of tubing. This array is composed of lengths of tubing and fittings that may total several hundred meters in length. The array may be manifold-fed, straight tubes, or serpentine. The array of tubing is heated to a carefully monitored temperature by the firebox. A stream of feedstock, frequently diluted with steam, is forced through the heated tubing under pressure at a high velocity, and the product quenched as it exits. The array is commonly operated at a temperature greater than 750° C.

Catalytic methods of improving olefins yield are particularly difficult to implement. Catalytic cracking and catalytic dehydrogenation requires acidic surface sites to initiate the reaction. These sites are prone to coking, the buildup of carbon deposits, which deactivates the sites. Control of heat transfer under catalytic conditions is also difficult. Because catalytic dehydrogenation reactions are highly endothermic, heat transfer to the catalyst surface is vital to operation. Auto-thermal reactions in steam and air mixture have been attempted, in efforts to address this problem, but it is not easy to control the catalytic processes under auto-thermal conditions. Because of these factors, implementing catalytic methods for increasing the olefins yield during steam thermal cracking is extremely challenging and has thus far been considered impractical due to these coking and heat transfer problems.

Coking causes other problems in the hydrocarbon cracking process in addition to the problems it causes for implementing catalytic methods. Carbon deposits restrict the flow of the gaseous stream and reduce heat transfer through the tube wall to the reactants. The temperature to which the tube is heated must then be raised to maintain a constant temperature in the reactant stream. This not only reduces process efficiency, but ultimately requires temperatures that exceed the structural and safety limitations of the equipment. A shutdown then becomes necessary to remove the carbon formation, a process known as decoking.

An ideal furnace component would catalytically facilitate the hydrocarbon cracking process and would be resistant to coke build up. It would be especially desirable to have a component that functioned both as a cracking catalyst and also catalytically aided in decoking via carbon gasification.

### SUMMARY OF THE INVENTION

One aspect of the present invention is a furnace component comprising an inorganic material that is exposed to a gas stream comprising hydrocarbon compounds, wherein at least a portion of the exposed inorganic material comprises a catalyst that promotes a hydrocarbon reaction to produce an olefin. Examples of suitable inorganic materials include, but are not limited to ceramic, glass, and glass-ceramic materials such as magnesium oxide, barium aluminosilicate, and borosilicate. The catalyst may be chosen from the group consisting of rare earth metal compounds, transition metal compounds, precious metal compounds and non-metal oxides. The inorganic material coating may further comprise a second catalyst that promotes carbon gasification. In one embodiment of the present invention, the second catalyst is chosen from the group consisting of alkali metal, alkaline earth metals, transition metals, and precious metals, and their compounds. In another embodiment of the present invention, the second catalyst comprises the same material or additional material as that of the first catalyst that promotes olefin formation.

According to one embodiment of the present invention, the inorganic material is coated onto the inside wall of a hydrocarbon cracking reactor. Alternatively, the inorganic material may be particles, powder, beads or monolith that are structurally contained in the furnace.

Another aspect of the present invention provides a method of making a furnace component, the method comprising the steps of: a) melting together the components of a base material and a catalyst that promotes a hydrocarbon reaction to produce an olefin and, b) cooling the melt to provide a solid composition. According to one embodiment of the present invention, the melt may be rolled or pressed into ribbons or sheets prior to cooling. The method may further comprise the steps of c) milling the solid composition to yield a powder and, d) heating the powder to induce ceraming. The further shaping of the powder into beads, monoliths or other structures may also be applied. The present furnace component may be used to replace existing furnace components or may be added to existing components. According to one aspect of the present invention the residence time of the gas stream in the furnace may be very short; for example ranging from about 0.001 s to about 0.1 s or even as short as 1 μs.

### BRIEF DESCRIPTION OF THE DRAWINGS

Other objects and commercial advantages of the invention will become apparent upon reading the following detailed description and upon reference to the FIGURES.

FIG. 1 is the results for ethane steam cracking using a furnace component comprising barium disilicate glass-ceramic material incorporating catalytically active components.

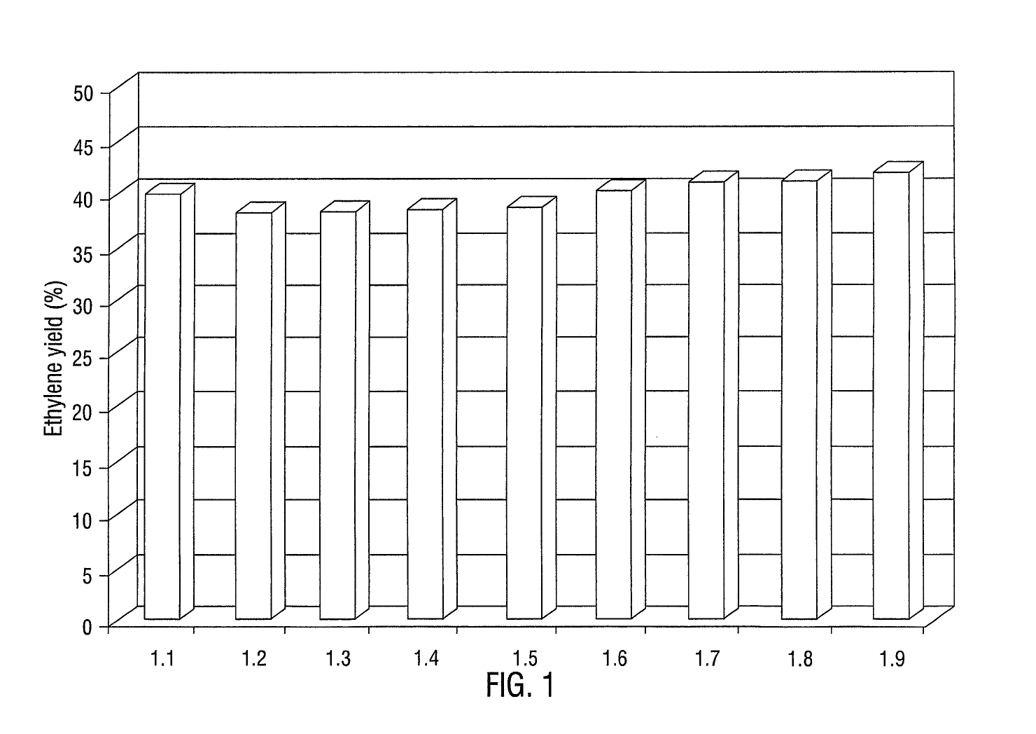

FIG. 2 is the relative change in ethylene yield during ethane steam cracking using a furnace component comprising barium disilicate glass-ceramic material incorporating catalytically active components.

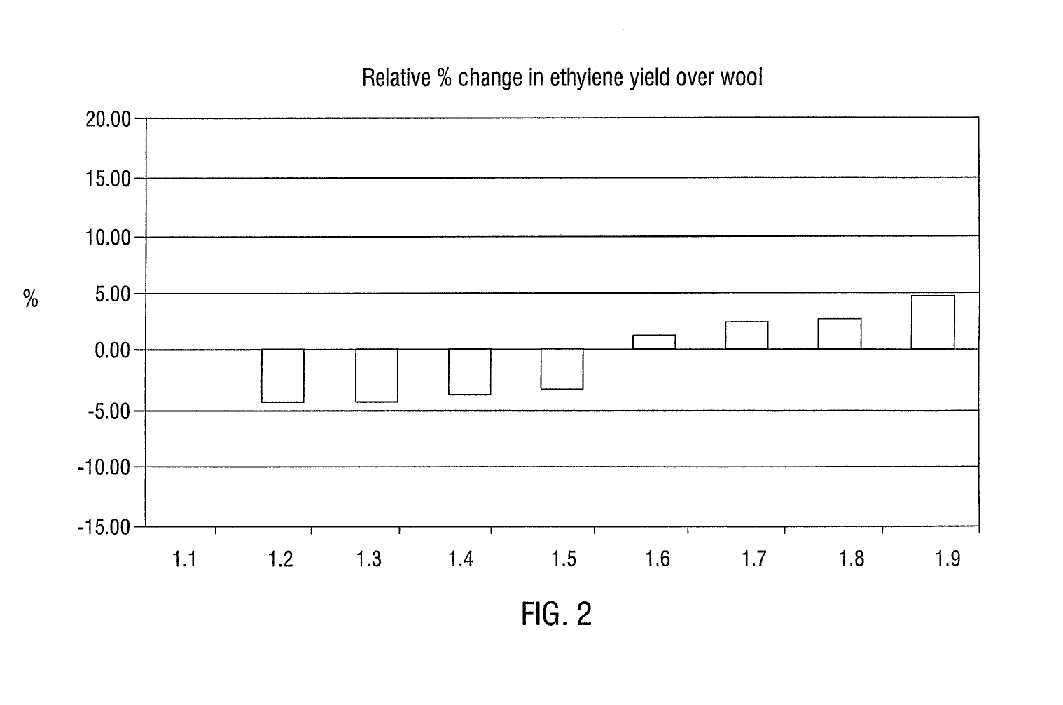

FIG. 3 is the results for ethane steam cracking using a furnace component comprising magnesium oxide glass-ceramic materials incorporating catalytically active components.

FIG. 4 is the relative change in ethylene yield compared to glass wool during ethane steam cracking using a furnace component comprising magnesium oxide glass-ceramic material incorporating catalytically active components.

FIG. 5 is the results for ethane steam cracking using a furnace component comprising alkaline earth zinc borosilicate glass-ceramic materials incorporating catalytically active components.

FIG. 6 is the relative change in ethylene yield compared to glass wool during ethane steam cracking using a furnace component comprising alkaline earth zinc borosilicate glass-ceramic materials incorporating catalytically active components.

While the invention is susceptible to various modifications and alternative forms, specific embodiments thereof have been shown by way of example in the drawings and are herein described in detail. Those skilled in the art will appreciate, however, that these FIGURES are schematic only and that they omit process details that are not particularly relevant to the present invention. It should be further understood that the description herein of specific embodiments is not intended to limit the invention to the particular forms disclosed; but on the contrary, the intention is to cover all modifications, equivalents, and alternatives falling within the spirit and scope of the invention as defined by the appended claims.

### DESCRIPTION OF ILLUSTRATIVE EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

A feature of the present invention provides active material compositions with good coke resistance that catalytically improve olefins yield under steam cracking conditions. These compositions enhance olefins yield by selectively participating in the free radical reaction pathway and altering the pathway to favor olefins as products. Without being bound by theory, it is believed that steam thermal cracking is a free radical pathway as depicted below. These reactions are non-selective in the gas phase since any two radicals can easily combine to form a product. The probability of forming ethylene as a product is determined by the radical concentrations and reaction conditions. Some industrial practices, such as diluting the radical concentrations using steam and/or decreasing the residence time by using high space velocity (mili-second) have been attempted in a effort to maximize the yield of olefin product.

Initiation C₂H₆→2 Ch₃.,

Hydrogen Abstraction CH₃.+C₂H₆→Ch₄+C₂H₅.

Hydrogen Dissociation C₂H₅.→C₂H₄+H.

Hydrogen Abstraction H.+C₂H₆→H₂+C₂H₅.

Recombination H.+C₂H₅.→C₂H₆

A surface that actively participate or interacts with the gas phase radicals can potentially alter the reaction path. A feature of the present invention is a surface that selectively interacts with gas phase ethyl radicals and promotes the dissociation of a hydrogen atom from the ethyl radical, thus increasing the yield of ethylene product. Although any transition metal oxide with free electrons in the p, d, or f orbitals may be capable of interacting or exchanging electrons with an ethyl radical, some metal oxides may be easily reduced at high temperatures in hydrogen or hydrocarbon atmospheres. Therefore, these metal oxides should not be used here due to the coking propensity on the metal surface. It is preferred to bond these metal oxides chemically into an inorganic material structure to prevent reduction in hydrogen or hydrocarbon and subsequent coke formation. The metal oxides referred to here are transition metal, precious metal, and rare-earth oxides and their compounds. Some non-metal oxides such as boron oxide and phosphorus oxide can also be used because of their electron exchange capability.

Accordingly, one aspect of the present invention is a furnace component comprising the inorganic material, wherein at least a portion of the exposed inorganic material comprises a catalyst that promotes the dissociation of a hydrogen atom from an ethyl radical.

Particularly suitable catalysts are metals and their compounds from Group IIA, IIIA, IVA, VA, IIB, IIIB, VB, VIB, VIIB and VIIIB. Examples include platinum, palladium, iridium, rhodium, ruthenium, lanthanum, nickel, cobalt, chromium, zinc, iron, barium, phosphorous and their compounds. The particular catalyst may be chosen according to its cost and its compatibility with the particular system in which it is to be employed. The minimum amount of catalyst employed is an effective amount to promote olefin production. The maximum is limited by the material cost and enhanced effectiveness. Preferably, at least about 0.05 weight % of catalyst is employed. Amounts greater than about 15 weight %, while effective, may not warrant the cost.

The composition, as well as the physical properties, of the inorganic material will depend on the particular application involved. For example, any element known to poison, or otherwise be detrimental to, a particular process should be avoided. Also, the inorganic material should not soften, recrystallize, or otherwise undergo detrimental change at the maximum temperature of the process in which it is used.

Where the feedstock is diluted with another material, the active furnace component should be unaffected by the diluent. For example, hydrocarbon cracking is often carried out in the presence of steam. In this case, the coating should not physically or chemically interact with the steam. An inorganic material suited to present purposes should exhibit these characteristic features:

1. A composition free from elements detrimental to a thermal cracking process.

2. Capability of withstanding operating temperatures of at least 850° C. without detrimental physical or chemical change.

3. Thermal expansion characteristics compatible with austenitic-type metals and their alloys.

4. Processing temperatures below a temperature at which the metal substrate undergoes change.

Any inorganic material that meets these several conditions may be employed. The alkaline earth metal borates and borosilicates, alkaline earth metal silicates, as well as magnesium oxide based materials may be particularly suitable.

A particularly suitable magnesium oxide based ceramic or glass ceramic material may comprise from about 5 to about 65 weight % MgO, preferably from about 5 to about 50 weight % MgO and from about 15 to about 95 weight % B₂O₃. An alternative magnesium oxide based ceramic or glass-ceramic material may comprise from about 5 to about 65 weight % MgO and from about 10 to about 95 weight % P₂O₅. A particularly suitable alkaline earth metal silicate may comprise from about 20 to about 65 weight % B₂O₃, from about 20 to about 65 weight % SiO₂ and up to about 45 weight % Al₂O₃. A particularly suitable alkaline earth metal borate may comprise from about 15 to about 60 weight % SiO₂, from about 5 to about 50 weight % MgO, and from about 5 to about 50 weight % B₂O₃. A particularly suitable barium aluminosilicate may comprise from about 20 to about 65 weight % BaO, from about 20 to about 65 weight % SiO₂, and up to about 45 weight % Al₂O₃.

In addition to improving olefins yield, the glass-ceramic composition may also be designed to decrease coke accumulation in the reactor. One way to remove thermal coke is to gasify the coke into its gaseous products, CO and CO₂, using steam. If the coke gasification rate can be tailored to be equal to or greater than thermal coke formation rate, thermal coke accumulation can be completely eliminated. However, the steam gasification rate of coke is usually very slow under normal steam cracking conditions. Therefore, catalyst or catalytically-active surface sites in inorganic material compositions are needed to accelerate the coke gasification rate. Suitable catalysts include alkali metals, alkaline earth metals, transition metals, precious metals and their compounds. Depending on their compatibility with base inorganic material compositions, some of these gasification catalysts may be incorporated into base compositions. Some catalysts may be used for both enhancing ethylene yield and facilitating coke gasification.

A further aspect of the present invention is a method of preparing a furnace component comprising an inorganic material, wherein at least a portion of the exposed glass inorganic material comprises a catalyst that promotes the dissociation of a hydrogen atom from an ethyl radical. According to one embodiment of the present invention the method comprises the steps of a) melting together the components of a base glass-ceramic material and a catalyst that promotes a hydrocarbon reaction to produce an olefin, and b) cooling the melt to provide a solid composition. If the catalysts are metals, they may be added as their salts, nitrates or oxides. According to one embodiment of the present invention, the melt can be processed by rolling it into glass sheets, ribbons, or slabs. The solidified glass may be milled into powder, particles or formed into beads, a monolith or other structured body. According to one aspect of the present invention, a coated metal furnace component can be prepared by applying the free-flowing glass powder to a metal substrate and heating the substrate to a temperature at which the glass flows and wets the metal surface. The glass will preferably become sufficiently fluid to form a continuous, essentially non-porous coating. The coated substrate is then held at this temperature, or at a somewhat lower temperature for a time sufficient to permit ceraming. According to a particular embodiment of the present invention, the metal substrate is the inside wall of a hydrocarbon steam cracking reactor. The furnace component may also be used as a particular shaped or structured form such as beads or monoliths. Such forms can be packed (e.g. beads) or directly inserted (e.g. monoliths) directly into the furnace tube. The present invention is not limited to any particular shape, form or structure of the furnace component.

### EXAMPLES

### Example 1

Barium disilicate glass-ceramic materials were prepared by melting together SiO₂ (62.6 weight %), Al₂O₂ (5.29 weight %), BaO (31.3 weight %), and SrO (0.599 weight %) with 0.01 % by weight of the components of Table 1.

TABLE 1
Barium disilicate Glass-ceramic Olefin Cracking
Catalyst Compositions.

| Sample | Catalyst |
|---|---|
| 1.1 | Quartz Wool |
| 1.2 | RhCl₂ |
| 1.3 | RuCl₂ |
| 1.4 | None (Control) |
| 1.5 | IrCl₂ |
| 1.6 | AuCl₂ |
| 1.7 | PdCl₂ |
| 1.8 | PtCl₂ |
| 1.9 | RhO₆ |

The compositions were melted as homogeneous glasses at 1600° C. in platinum crucibles and then rolled into thin sheet by rolling the molten glass between rollers. The cooled glass ribbon was ground to powder with 6-8 μm mean particle size. The powder was then heated at 10° C./min to 1200° C. for 10 minutes, cooled at furnace rate to 1050° C. and held for 4 hr and then cooled at furnace rate to room temperature. The resulting cerammed mass was ground and sieved to retain particles with particle sizes from 40 to 60 mesh. About 2.5 g of 40 to 60 mesh active coating material were exposed to the following simulated steam cracking conditions:

| | |
|---|---|
| Steam to Ethane Ratio: | 1:3 |
| Overall Pressure: | ambient |
| Gas Temperature: | 850° C. |
| Overall Linear Velocity: | 0.01 to 0.5 m/s |

Steam cracking reactions were conducted in a reactor having 1.2″ (3.05 cm) diameter and a length of 18″ (45.72 cm). The reactor was constructed from quartz tubing with a wall thickness of 0.0625″ (0.159 cm), and I. D. of 1.0″ (2.54 cm). There was no preheating zone before the packed glass-ceramic active material. The active material samples had a geometric surface area equal to the interior surface area of the quartz tube reactor within the isothermal zone.

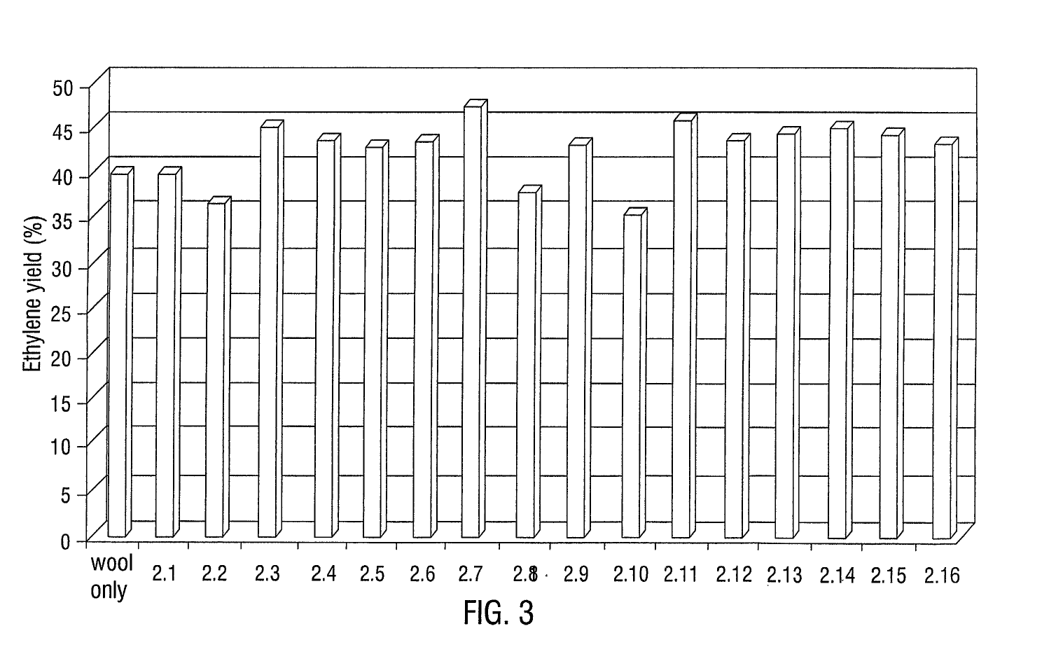

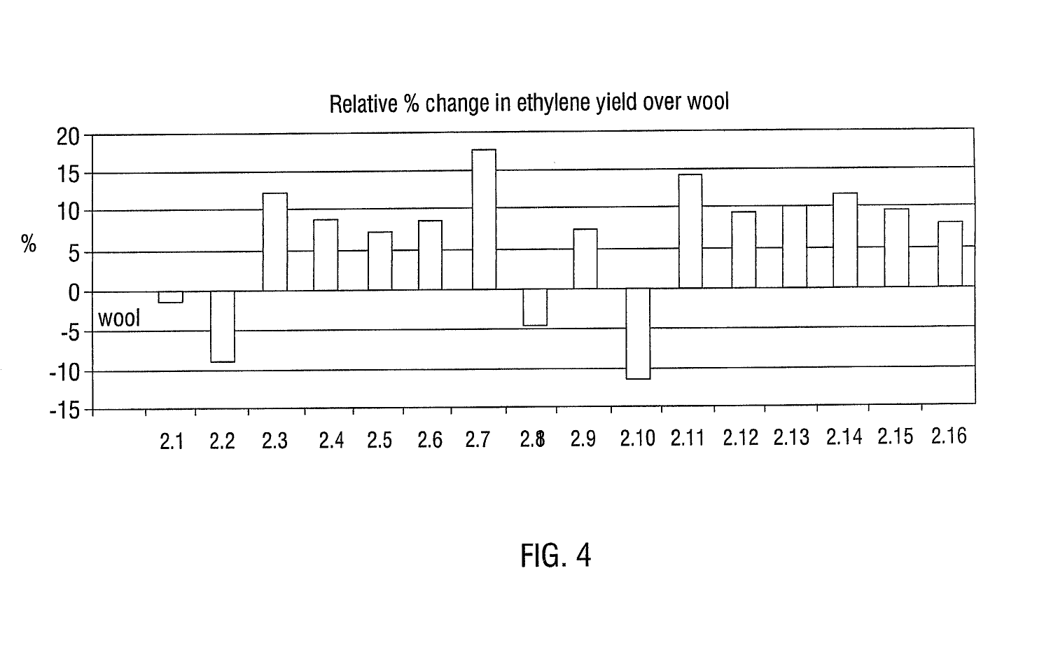

The testing results in ethane steam cracking are shown in FIG. 3. Their relative change in ethylene yield during the reaction is replotted in FIG. 4. The precious metal oxides of Pt, Pd, and Rh show about 1-5% ethylene yield increase. The order of their catalytic activity is Rh (5%)>Pt(3%)>=Pd(2-3%). Under these conditions, gold oxide, iridium oxide, and ruthenium oxide displayed little or no enhancement in ethylene yield.

### Example 2

Glass-ceramic materials having the compositions listed in Table 2 were prepared using a solid state reaction technique under static air. The MgO and boric anhydride (B₂O₃) were used in powdered form and the other oxides were decomposed from their corresponding nitrate precursors. All constituents were placed in a beaker 20 and stirred until the mixture appeared uniform. The mixtures were then processed in static air at 450° C. for 20 hours then at 600° C. for 2 hours.

TABLE 2
MgO Olefin Cracking Catalyst Compositions (in weight %).

| Sample | MgO | B₂O₃ | P₂O₅ | CrO₃ | Al₂O₃ | Cr₂O₃ | NiO | La₂O₃ | ZnO | SrO | BaO | Fe₂O₃ | CaO |
|---|---|---|---|---|---|---|---|---|---|---|---|---|---|
| 2.1 | 25 | 58 | | | | 17 | | | | | | | |
| 2.2 | 25 | 58 | | | | | 17 | | | | | | |
| 2.3 | 25 | 58 | | | | | | | 17 | | | | |
| 2.4 | 25 | 30 | 20 | | | 17 | | | | | | | |
| 2.5 | 25 | 30 | 20 | | | | | 17 | | | | | |
| 2.6 | 25 | 30 | | | | | | | | | | | 17 |
| 2.7 | 25 | 30 | 20 | | | | | | 17 | | | | |
| 2.8 | 25 | 30 | 20 | | | | | | | | | 17 | |
| 2.9 | 25 | 58 | | | 12 | 5 | | | | | | | |
| 2.10 | 25 | 30 | 15 | | 20 | | 10 | | | | | | |
| 2.11 | 30 | 35 | 10 | | 20 | | | 5 | | | | | |
| 2.12 | 30 | 35 | 10 | | 20 | | | 3 | | 2 | | | |
| 2.13 | 30 | 35 | 10 | | 20 | | | 3 | | | 2 | | |
| 2.14 | 30 | 35 | 10 | | 20 | 3 | | | | 2 | | | |
| 2.15 | 30 | 35 | 10 | | 20 | 3 | | | | | 2 | | |
| 2.16 | 25 | 35 | 10 | 10 | 20 | | | | | | | | |

The resulting cerammed mass was ground and sieved to retain particles with particle sizes from 40 to 60 mesh. About 2.5 g of 40 to 60 mesh active coating material were exposed to the following simulated steam cracking conditions:

| | |
|---|---|
| Steam to Ethane Ratio: | 1:3 |
| Overall Pressure: | ambient |
| Gas Temperature: | 850° C. |
| Overall Linear Velocity: | 0.01 to 0.5 m/s |

Steam cracking reactions were conducted in a reactor having 1.2″ (3.05 cm) diameter and a length of 18″ (45.72 cm). The reactor was constructed from quartz tubing with a wall thickness of 0.0625″ (0.159 cm), and I. D. of 1.0″ (2.54 cm). There was no preheating zone before the packed glass-ceramic active material. The active material samples had a geometric surface area equal to the interior surface area of the quartz tube reactor within the isothermal zone.

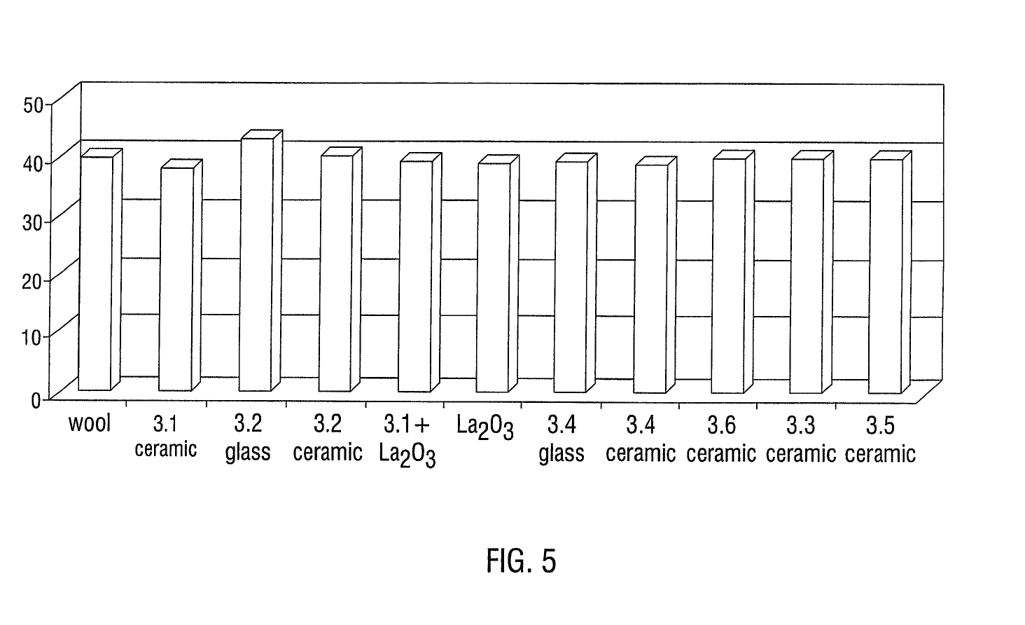

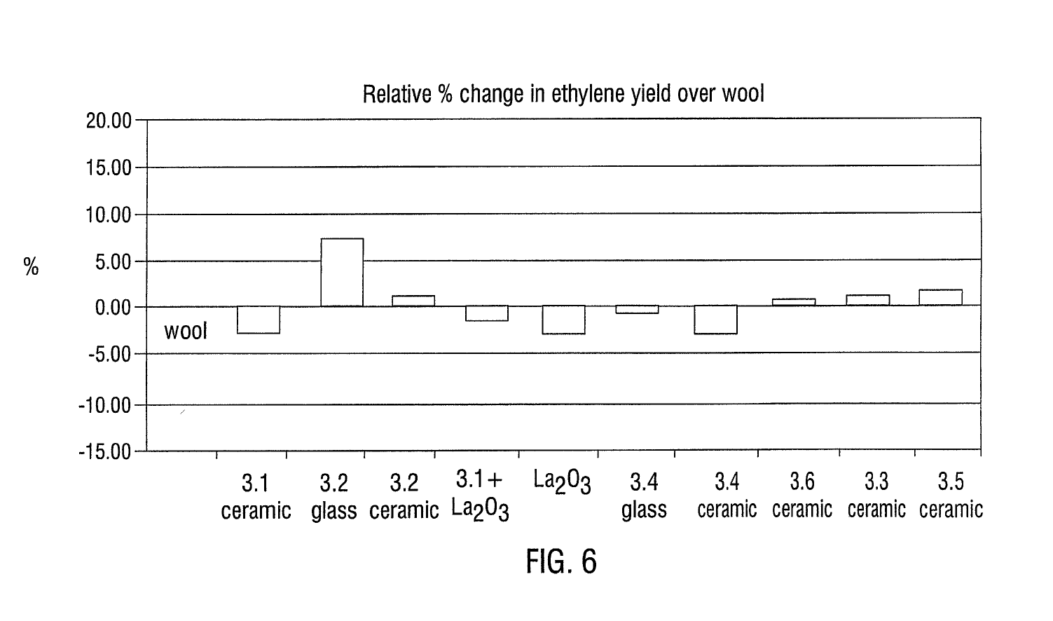

The testing results in ethane steam cracking are shown in FIG. 5. Their relative change in ethylene yield compared to quartz wool is shown in FIG. 6. It is clear that most compositions increased ethylene yield by at least 5%.

### Example 3

Alkaline earth zinc borosilicate glass-ceramic materials were prepared according to the compositions listed in Table 3. The batches were melted at 1450° C. for 6 hours in Pt crucibles, drigaged (poured into a pail of water), and then ground into 15-20 μm powder. One group of samples was used in steam cracking simulations as the glass. A second group of samples were further treated by pressing the powders into bars, ceraming them at 950° C. for 4 hours and then grinding them to 40-60 mesh powder. For comparison, a physical mixture of the same amount of La₂O₃ (2 weight %) with the alkaline earth zinc borosilicate glass and a pure sample of La₂O₃ were prepared and tested.

TABLE 3
Alkaline Earth Zinc borosilicate Olefin Cracking Catalyst Glass-ceramic
Compositions (in weight %).

| Sample | SiO₂ | B₂O₃ | MgO | ZnO | BaO | SrO | La₂O₃ | NiO | Co₃O₄ | Fe₂O₃ | Pt |
|---|---|---|---|---|---|---|---|---|---|---|---|
| 3.1 | 31.0 | 13.1 | 24.4 | 13.9 | 16.4 | 0.307 | | | | | |
| 3.2 | 31.0 | 12.9 | 23.9 | 13.7 | 16.1 | 0.301 | 1.95 | | | | |
| 3.3 | 31.0 | 12.9 | 23.9 | 13.7 | 16.1 | 0.301 | | 1.95 | | | |
| 3.4 | 31.0 | 12.9 | 23.9 | 13.7 | 16.1 | 0.301 | | | 1.95 | | |
| 3.5 | 31.0 | 12.9 | 23.9 | 13.7 | 16.1 | 0.301 | | | | 1.95 | |
| 3.6 | 31.6 | 13.1 | 24.4 | 13.9 | 16.4 | 0.307 | | | | | 0.0497 |
| 3.7 | 30.4 | 12.7 | 23.4 | 13.4 | 15.8 | 0.295 | | 1.91 | 1.91 | | |
| 3.8 | 30.4 | 12.7 | 23.4 | 13.4 | 15.8 | 0.295 | | 1.91 | | 1.91 | |
| 3.9 | 30.4 | 12.7 | 23.4 | 13.4 | 15.8 | 0.295 | | | 1.91 | 1.91 | |

About 2.5 g of 40 to 60 mesh active material was exposed to the following simulated steam cracking conditions:

| | |
|---|---|
| Steam to Ethane Ratio: | 1:3 |
| Overall Pressure: | ambient |
| Gas Temperature: | 850° C. |
| Overall Linear Velocity: | 0.01 to 0.5 m/s |

Steam cracking reactions were conducted in a reactor having 1.2″ (3.05 cm) diameter and a length of 18″ (45.72 cm). The reactor was constructed from quartz tubing with a wall thickness of 0.0625″ (0.159 cm), and I. D. of 1.0″ (2.54 cm). There was no preheating zone before the packed glass-ceramic active material. The active material samples had a geometric surface area equal to the interior surface area of the quartz tube reactor within the isothermal zone.

The testing results in ethane steam cracking are shown in FIG. 7. Their relative change in ethylene yield is shown in FIG. 8.

What is claimed is:

1. A furnace component that is exposed to a hydrocarbon containing gas stream, the furnace component comprising an inorganic material; wherein at least a portion of the exposed inorganic material comprises a catalyst that promotes a hydrocarbon reaction to produce an olefin.

2. A furnace component according to claim 1 wherein the inorganic material is a glass, glass-ceramic, or ceramic material.

3. A furnace component according to claim 2 wherein the inorganic material comprises 5-50 weight % MgO and 15-95 weight % B₂O₃.

4. A furnace component according to claim 2 wherein the inorganic material comprises 5-50 weight % MgO and 10-95 weight % P₂O₅.

5. A furnace component according to claim 2 wherein the inorganic material is a barium aluminosilicate.

6. A furnace component according to claim 5 wherein the glass-ceramic material comprises 20-65 weight % BaO, 20-65 weight % SiO₂, and up to 45 weight % Al₂O₃.

7. A furnace component according to claim 1 wherein the inorganic material is a borosilicate glass.

8. A furnace component according to claim 7 wherein the glass comprises 15-60 weight % SiO₂, 5-50 weight % MgO, and 5-50 weight % B₂O₃.

9. A furnace component according to claim 1 wherein the catalyst is chosen from the group consisting of rare earth metals, precious metals, transition metals, non-metals and their corresponding compounds.

10. A furnace component according to claim 9 wherein the catalyst is chosen from the group consisting of Pt, Pd, Ir, Rh, Ru, Ni, Co, Cr, Zn, Ca, Fe, B, P, Mo and their corresponding compounds.

11. A furnace component according to claim 1 wherein the inorganic material is adhered to the surface of a metal substrate.

12. A furnace component according to claim 11 wherein the metal substrate is the inside wall of a hydrocarbon cracking reactor.

13. A furnace component according to claim 1 wherein the inorganic material comprises particles, powder, beads, monoliths, or other structured shapes.

14. A furnace component according to claim 1 wherein the inorganic material is contained within a packed bed.

15. A furnace component according to claim 1 wherein the inorganic material is inserted into the furnace.

16. A furnace component according to claim 1, further comprising a second catalyst promoting carbon gasification.

17. A furnace component according to claim 16 wherein the second catalyst is chosen from the group consisting of alkali metals, alkaline earth metals, transition metals, and precious metals and their compounds.

18. A furnace component according to claim 17 wherein the second catalyst is K, Ca, Ba, P, Pd, Rh, Mn, V and their compounds.

19. A furnace component according to claim 16 wherein the second catalyst comprises the same material as that of the catalyst of claim 1.

20. A method of making a furnace component, the method comprising;
a) melting together the components of a base glass-ceramic material and a catalyst that promotes a carbon reaction to produce an olefin and,
b) cooling the melt to provide a solid composition.

21. The method according to claim 20 further comprising;
c) milling the solid composition to yield a powder, and
d) heating the powder to induce ceraming.

22. A method according to claim 20 wherein the components of the base glass ceramic comprises 5-65 weight. % MgO and 15-95 weight. % B₂O₃.

23. A method according to claim 20 wherein the components of the base glass ceramic comprises 15-65 weight % MgO and 10-95 weight. % P₂O₅.

24. A method according to claim 20 wherein the components of the base glass ceramic comprises 20-65weight % BaO, 20-65 weight % SiO₂, and up to 15 weight % Al₂O₃.

25. A method according to claim 20 wherein the components of the base glass ceramic comprises 15-60 weight % SiO₂, 5-50 weight % MgO, and 5-50 weight % B₂O₃.

26. A method according to claim 20 wherein the catalyst is chosen from the group consisting of rare earth metals, rare earth metal oxides, transition metals, transition metal oxides and non-metal oxides

27. A method according to claim 20 wherein the catalyst is chosen from the group consisting of Pt, Pd, Ir, Rh, Ru, Ni, Co, Cr, Zn, Ca, Fe, B, P, Mo and their corresponding compounds.
